(19) United States
(12) Patent Application Publication
(10) Pub. No.: US 2025/0254539 A1
(43) Pub. Date: Aug. 7, 2025

(54) Artificial Intelligence (AI) on an Edge Network

(71) Applicant: Akamai Technologies, Inc., Cambridge, MA (US)

(72) Inventors: Andrew F. Champagne, Ware, MA (US); Michael Meridith, Chapel Hill, NC (US); Charles E. Gero, Quincy, MA (US); Ramanath Iyer, Cambridge, MA (US)

(21) Appl. No.: 19/044,123

(22) Filed: Feb. 3, 2025

Related U.S. Application Data
(60) Provisional application No. 63/549,463, filed on Feb. 3, 2024.

(51) Int. Cl. H04W 24/02; H04L 41/16

(52) U.S. Cl. CPC H04W 24/02; H04L 41/16

(57) ABSTRACT

This disclosure provides for Artificial Intelligence (AI) support in a distributed computing environment. First machine learning models are configured in a first network located between requesting clients, and a second network, which hosts a second machine learning model, such as a Large Language Model (LLM). Significant processing efficiencies are obtained by provisioning these ML models on the respective networking components. Preferably, and as between a first machine learning model and the second machine learning model, the first machine learning model provides inferencing at a lower cost but with less accuracy. In response to receipt of a request by a first machine learning model, a response is generated. The response is forwarded onward to the second machine learning model for additional handling. The first machine learning model executes primarily on Central Processing Units (CPUs), and the second machine learning model executes primarily on Graphics Processing Units (GPUs).

### BACKGROUND OF THE INVENTION

This application relates generally to optimizing distributed computing networks.

Distributed computer systems are well-known in the prior art. One such distributed computer system is a “content delivery network” (CDN) or “overlay network” that is operated and managed by a service provider. The service provider typically provides the content delivery service on behalf of third parties (customers) who use the service provider's shared infrastructure. A distributed system of this type typically refers to a collection of autonomous computers linked by a network or networks, together with the software, systems, protocols and techniques designed to facilitate various services, such as content delivery, web application acceleration, or other support of outsourced origin site infrastructure. A CDN service provider typically provides service delivery through digital properties (such as a website), which are provisioned in a customer portal and then deployed to the network.

Machine learning (ML) is the study of algorithms and mathematical models that computer systems use to progressively improve their performance on a specific task. Machine learning algorithms build a mathematical model of sample data, known as “training data”, in order to make predictions or decisions without being explicitly programmed to perform the task. Typically, ML tasks are classified in several ways.

In supervised learning, an algorithm builds a mathematical model of a set of data that contains both the inputs and the desired outputs. For example, if the task were determining whether an image contained a certain object, the training data for a supervised learning algorithm includes images with and without that object (the input), and each image is given a label (the output) designating whether it contained the object. In supervised learning, the algorithm trains on labeled historic data and learns general rules that map input to output/target. The discovery of relationships between the input variables and the label/target variable in supervised learning is done with a training set, and the system learns from the training data. There are two subsets to supervised learning: regression techniques for continuous response prediction, and classification techniques for discrete response prediction. The most widely used supervised learning algorithms are Support Vector Machines, linear regression, logistic regression, naive Bayes, and neural networks (NNs). Semi-supervised learning algorithms develop mathematical models from incomplete training data, where a portion of the sample inputs are missing the desired output. In unsupervised learning, the algorithm builds a mathematical model of a set of data which contains only inputs and no desired outputs. Unsupervised learning algorithms are used to find structure in the data, like grouping or clustering of data points.

A large language model (LLM) is a language model notable for its ability to achieve general-purpose language generation. LLMs acquire these abilities by learning statistical relationships from text documents during a computationally intensive self-supervised and semi-supervised training process. LLMs are artificial neural networks, the largest and most capable of which are built with a transformer-based architecture. Formally, a neural network is a function g: X→Y, where X is an input space, and Y is an output space representing a categorical set in a classification setting (or a real number in a regression setting). For a sample x that is an element of X, g(x)=f_{L}(f_{L-1}( . . . ((f₁(x)))). Each fᵢ represents a layer, and f_{L} is the last output layer. The last output layer creates a mapping from a hidden space to the output space (class labels), typically through a SoftMax function that outputs a vector of real numbers in the range [0, 1] that add up to 1. The output of the SoftMax function is a probability distribution of input x over C different possible output classes.

Typically, LLMs are language models with many parameters, and are trained with self-supervised learning on a vast amount of text. The largest and most capable LLMs are generative pretrained transformers (GPTs). Modern models can be fine-tuned for specific tasks or guided by prompt engineering. These models acquire predictive power regarding syntax, semantics, and ontologies inherent in human language corpora.

In an overlay network such as a CDN, individual nodes (e.g., edge servers) have “local” knowledge. A machine learning (ML) model associated with activities at an edge server can be built, but that model only encodes expertise that in effect is local to that edge server.

There have been proposals to provide collaborative machine learning in an edge network. One example is described in U.S. Publication No. 2020/0175419, in the name of Akamai Technologies, Inc. In this approach, individual nodes (e.g., edge machines) in an overlay network (e.g., a CDN) each build local models associated with a particular behavior of interest. Through a gossip protocol, or some other equivalent communication mechanism, nodes exchange some portion of their ML models between or among each other. The portion of the local model that is exchanged with one or more other nodes encodes or encapsulates relevant knowledge (learned at the source node) for the particular behavior of interest; in this manner relevant transfer learning is enabled such that individual nodes (namely, their associated ML models) become smarter. In this scheme, a number of “partial” models are built locally, and then relevant knowledge is shared among the machines to facilitate a collaborative, cross-validation of the relevant knowledge-base. Sets of machines that collaborate in this manner converge their models toward some solution (e.g., a steady state) that is then used to facilitate the overlay network function or optimization. In this manner, the exchange of local knowledge among the nodes creates an emergent behavioral profile that is then used to control the edge machine behavior. Relevant functions that can be managed with this ML front-end include, without limitation, predictive pre-fetching, image management, anomaly detection (for a security function) forecasting to allocate resources (e.g., within an edge region), and others.

While AI/ML solutions such as described provide significant advantages, their implementation presents significant practical difficulties. For example, neural networks such as large language models (LLMs) require significant processing support in terms of power consumption, computation, and memory. Indeed, it has been argued that the computational demands of deep learning applications are unsustainable, primarily because both the size of the network and the number of data points must grow rapidly to improve performance, and further because the cost of training scales with the product of the number of parameters and the number of data points in the model. In addition, as LLMs become larger and more complex, their cost of execution (in terms of GPUs and other computing resource support) becomes prohibitive for many types of use cases.

### SUMMARY

This disclosure provides for Artificial Intelligence (AI) support in a distributed computing environment. In this approach, one or more first machine learning models are configured in a first network located between requesting clients, and a second network. The second network hosts a second machine learning model, such as a Large Language Model (LLM). According to this approach, significant processing efficiencies are obtained by provisioning these ML model elements on the respective networking components. Preferably, and as between at least one first machine learning model and the second machine learning model, the first machine learning model provides inferencing at a lower cost but with less accuracy. In response to receipt of a request by a given one of the first machine learning models, a response is generated. The response (or some variant thereof) is then forward onward to the second machine learning model for additional handling. In a representative embodiment, the at least one first machine learning model executes primarily on one or more Central Processing Units (CPUs), and the second machine learning model executes primarily on one or more Graphics Processing Units (GPUs).

The foregoing has outlined some of the more pertinent features of the disclosed subject matter. These features should be construed to be merely illustrative. Many other beneficial results can be attained by applying the disclosed subject matter in a different manner or by modifying the subject matter as will be described.

### BRIEF DESCRIPTION OF DRAWINGS

FIG. 1 depicts a content delivery network services architecture;

FIG. 2 depicts a representative edge server machine architecture;

FIG. 3 depicts an edge server-based system of collaborative machine learning;

FIG. 4 depicts a representative interaction of an end user with a Large Language Model (LLM);

FIG. 5 depicts a first embodiment of this disclosure wherein a set of one or more cheap models are positioned in front of an LLM to perform initial processing on a request;

FIG. 6 depicts a second embodiment of this disclosure wherein the one or more cheap models execute in a cloud compute infrastructure;

FIG. 7 depicts a third embodiment of this disclosure wherein the one or more cheap models execute on an edge network, and a back-end LLM executes in a cloud compute infrastructure;

FIG. 8 depicts a use case wherein a set of cheap models are configured to operate collaboratively to provide a firewall-type functionality for a back-end LLM;

FIG. 9 depicts a fourth embodiment of this disclosure wherein an edge network supports a Retrieval Augmented Generation (RAG) functionality;

FIG. 10 depicts a fifth embodiment wherein a network of cheap models are configured to inform each other of their respective inferencing results;

FIG. 11 depicts a sixth embodiment wherein the network of cheap models are organized in a tiered arrangement;

FIG. 12 depicts a seventh embodiment wherein different cheap models have differing capabilities relative to one another;

FIG. 13 depicts how the various sub-networks depicted in FIG. 12 are useful to adjust the machine learning models during training; and

FIG. 14 depicts an eighth embodiment wherein the network of cheap models are structured with additional logic.

### DETAILED DESCRIPTION

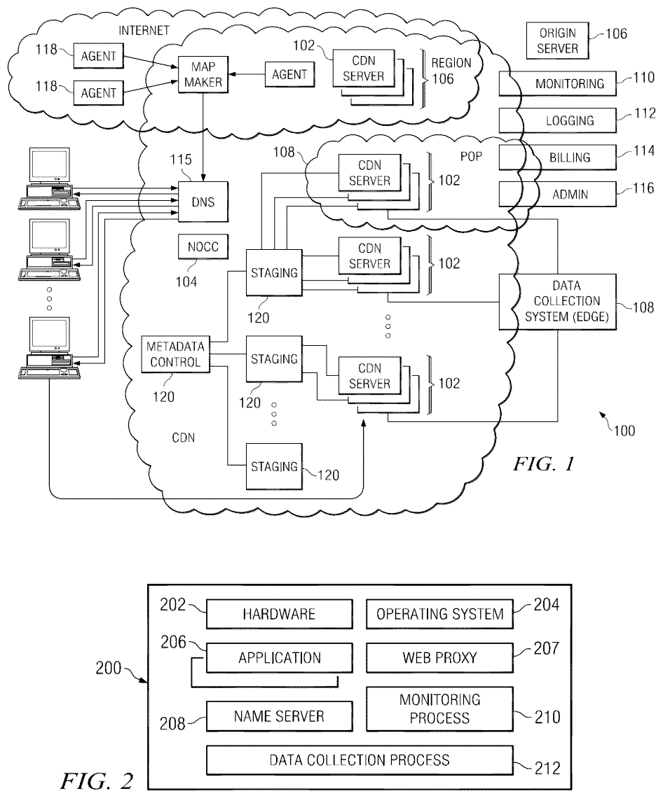

In a known system, such as shown in FIG. 1, a distributed computer system 100 is configured as a content delivery network (CDN) and is assumed to have a set of machines 102a-n distributed around the Internet. Typically, most of the machines are servers located near the edge of the Internet, i.e., at or adjacent end user access networks. A network operations command center (NOCC) 104 manages operations of the various machines in the system. Third party sites, such as web site 106, offload delivery of content (e.g., HTML, embedded page objects, streaming media, software downloads, and the like) to the distributed computer system 100 and, in particular, to “edge” servers. Typically, content providers offload their content delivery by aliasing (e.g., by a DNS CNAME) given content provider domains or sub-domains to domains that are managed by the service provider's authoritative domain name service. End users that desire the content are directed to the distributed computer system to obtain that content more reliably and efficiently. Although not shown in detail, the distributed computer system may also include other infrastructure, such as a distributed data collection system 108 that collects usage and other data from the edge servers, aggregates that data across a region or set of regions, and passes that data to other back-end systems 110, 112, 114 and 116 to facilitate monitoring, logging, alerts, billing, management and other operational and administrative functions. Distributed network agents 118 monitor the network as well as the server loads and provide network, traffic and load data to a DNS query handling mechanism 115, which is authoritative for content domains being managed by the CDN. A distributed data transport mechanism 120 may be used to distribute control information (e.g., metadata to manage content, to facilitate load balancing, and the like) to the edge servers.

As illustrated in FIG. 2, a given machine 200 comprises commodity hardware (e.g., an Intel Pentium processor) 202 running an operating system kernel (such as Linux or variant) 204 that supports one or more applications 206a-n. To facilitate content delivery services, for example, given machines typically run a set of applications, such as an HTTP proxy 207 (sometimes referred to as a “global host” process), a name server 208, a local monitoring process 210, a distributed data collection process 212, and the like. For streaming media, the machine typically includes one or more media servers, such as a Windows Media Server (WMS) or Flash server, as required by the supported media formats.

A CDN edge server is configured to provide one or more extended content delivery features, preferably on a domain-specific, customer-specific basis, preferably using configuration files that are distributed to the edge servers using a configuration system. A given configuration file preferably is XML-based and includes a set of content handling rules and directives that facilitate one or more advanced content handling features. The configuration file may be delivered to the CDN edge server via the data transport mechanism. U.S. Pat. No. 7,111,057 illustrates a useful infrastructure for delivering and managing edge server content control information, and this and other edge server control information can be provisioned by the CDN service provider itself, or (via an extranet or the like) the content provider customer who operates the origin server.

The CDN may include a storage subsystem, such as described in U.S. Pat. No. 7,472,178, the disclosure of which is incorporated herein by reference.

The CDN may operate a server cache hierarchy to provide intermediate caching of customer content; one such cache hierarchy subsystem is described in U.S. Pat. No. 7,376,716, the disclosure of which is incorporated herein by reference.

The CDN may provide secure content delivery among a client browser, edge server and customer origin server in the manner described in U.S. Publication No. 20040093419. Secure content delivery as described therein enforces SSL-based links between the client and the edge server process, on the one hand, and between the edge server process and an origin server process, on the other hand. This enables an SSL-protected web page and/or components thereof to be delivered via the edge server. To enhance security, the service provider may provide additional security associated with the edge servers. This may include operating secure edge regions comprising edge servers located in locked cages that are monitored by security cameras.

As an overlay, the CDN resources may be used to facilitate wide area network (WAN) acceleration services between enterprise data centers (which may be privately-managed) and third party software-as-a-service (SaaS) providers.

In a typical operation, a content provider identifies a content provider domain or sub-domain that it desires to have served by the CDN. The CDN service provider associates (e.g., via a canonical name, or CNAME) the content provider domain with an edge network (CDN) hostname, and the CDN provider then provides that edge network hostname to the content provider. When a DNS query to the content provider domain or sub-domain is received at the content provider's domain name servers, those servers respond by returning the edge network hostname. The edge network hostname points to the CDN, and that edge network hostname is then resolved through the CDN name service. To that end, the CDN name service returns one or more IP addresses. The requesting client browser then makes a content request (e.g., via HTTP or HTTPS) to an edge server associated with the IP address. The request includes a host header that includes the original content provider domain or sub-domain. Upon receipt of the request with the host header, the edge server checks its configuration file to determine whether the content domain or sub-domain requested is actually being handled by the CDN. If so, the edge server applies its content handling rules and directives for that domain or sub-domain as specified in the configuration. These content handling rules and directives may be located within an XML-based “metadata” configuration file.

More generally, the techniques described herein are provided using a set of one or more computing-related entities (systems, machines, processes, programs, libraries, functions, or the like) that together facilitate or provide the described functionality described above. In a typical implementation, a representative machine on which the software executes comprises commodity hardware, an operating system, an application runtime environment, and a set of applications or processes and associated data, which provide the functionality of a given system or subsystem. As described, the functionality may be implemented in a standalone machine, or across a distributed set of machines. The functionality may be provided as a service, e.g., as a SaaS solution.

Because the CDN infrastructure is shared by multiple third parties, it is sometimes referred to herein as a multi-tenant shared infrastructure. The CDN processes may be located at nodes that are publicly-routable on the Internet, within or adjacent nodes that are located in mobile networks, in or adjacent enterprise-based private networks, or in any combination thereof.

As used herein, an “edge server” refers to a CDN (overlay network) edge machine or server process used thereon. In the above-described context, a “region” typically is a set of edge servers or machines that are co-located with one another.

As mentioned above, it is known to provide collaborative machine learning in an edge network. One example is described in U.S. Publication No. 2020/0175419. In this approach, individual nodes (e.g., edge machines) in an overlay network (e.g., a CDN) each build local models associated with a particular behavior of interest. Through a gossip protocol, or some other equivalent communication mechanism, nodes exchange some portion of their ML models between or among each other. The portion of the local model that is exchanged with one or more other nodes encodes or encapsulates relevant knowledge (learned at the source node) for the particular behavior of interest; in this manner relevant transfer learning is enabled such that individual nodes (namely, their associated ML models) become smarter. In this scheme, a number of “partial” models are built locally, and then relevant knowledge is shared among the machines to facilitate a collaborative, cross-validation of the relevant knowledge-base. Sets of machines that collaborate in this manner converge their models toward some solution (e.g., a steady state) that is then used to facilitate the overlay network function or optimization. In this manner, the exchange of local knowledge among the nodes creates an emergent behavioral profile that is then used to control the edge machine behavior. Relevant functions that can be managed with this ML front-end include, without limitation, predictive pre-fetching, image management, anomaly detection (for a security function) forecasting to allocate resources (e.g., within an edge region), and others.

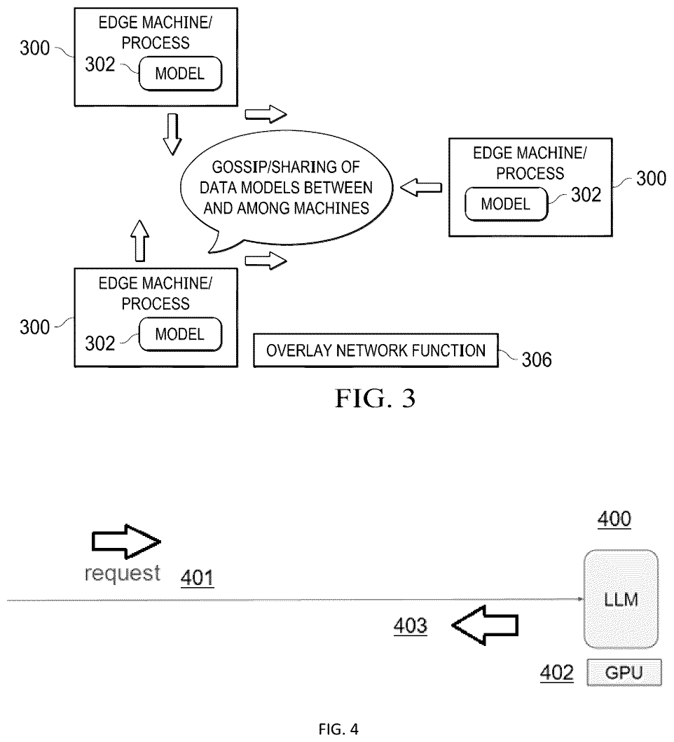

FIG. 3 depicts the basic operation mechanism of the above-described collaborative approach. In this example scenario, a set of edge machines 300 are provided. The machines act as peer computing nodes in a multi-machine collaborative learning technique. To this end, each edge machine builds a local machine learning model 302 of a particular behavior of interest. The edge machines communicate these models (or portions thereof) with one another, e.g., by a gossip protocol or other group communication mechanism. Using knowledge obtained from one or more its peers, a machine 300 then adjusts its local model such that the local classification algorithm being executed by a machine is augmented or enhanced by the knowledge that was taken in by one or more of its peers. The notion of adjusting the local model should be broadly construed as updating, modifying, enhancing, refining, rebuilding, and so forth. When the problem addressed is stationary in nature (i.e., it has a solution that evolves to a solution over time), augmented models eventually converge to a steady state solution. Whether the problem (captured by the data being modeled) is stationary or non-stationary, a local machine then uses the augmented model to facilitate an overlay network optimization or function.

In one embodiment, a collaborative model that is built in the manner described above is used to provide a content pre-fetching mechanism 306, namely, one that is built on machine learning that learns where to pre-position content. A pre-fetch mechanism may be one such as described in U.S. Pat. Nos. 8,447,837, 9,819,721, and others, commonly-owned by Akamai Technologies, Inc. of Cambridge, Massachusetts. In another embodiment, the collaborative model is used to facilitate an anomaly detection, such as in the context of a web application firewall, a solution described in commonly-owned U.S. Pat. No. 8,458,769. Another use case involves using the modified model for an overlay networking routing function, such as DNS-based mapping.

By way of further background, cloud computing is an information technology delivery model by which shared resources, software and information are provided on-demand over a network (e.g., the publicly-routed Internet) to computers and other devices. This type of delivery model has significant advantages in that it reduces information technology costs and complexities, while at the same time improving workload optimization and service delivery. In a typical use case, an application is hosted from network-based resources and is accessible through a conventional browser or mobile application. Cloud compute resources typically are deployed and supported in data centers that run one or more network applications, typically using a virtualized architecture wherein applications run inside virtual servers, or virtual machines (VMs), which are mapped onto physical servers in the data center. The virtual machines typically run on top of a hypervisor, which allocates physical resources to the virtual machines. Traditional cloud computing Points of Presence (POPs) are centralized hubs with a high level of computing infrastructure available to perform compute tasks. A representative cloud compute infrastructure is Linode® compute, also available as an Akamai® commercial service offering.

In the above-referenced infrastructure, a “Host” refers to a bare-metal machine running software. A “Compute Host” is a machine that manages virtual machines VMs and typically runs associated administrative software for a cloud compute infrastructure. A “Guest VM” is a virtual machine running on a Compute Host, and it may be a customer VM or an infrastructure VM. A “Datacenter” (CD) typically is a customer-facing abstraction for cloud compute infrastructure, typically a cluster of Guest VMs. A set of such regions and associated network infrastructure (e.g., within a metropolitan area or “metro”) which shares connectivity to the Internet is sometimes referred to as an Equivalence-Class-Of-Region (“ECOR”). There may be multiple ECORs in any given city (although there may be cases where an ECOR spans physical nearby buildings, such as with DWDM interconnects).

In this infrastructure, a representative VM has associated therewith persistent storage, the amount of which typically varies based on size and type, and memory (RAM). The persistent storage typically is built on enterprise-grade SSDs (solid state disks). The VM's persistent storage space can be allocated to individual disks. Disks can be used to store any data, including the operating system, applications, and files. A representative VM is equipped with two (2) disks, a large primary disk used to store the OS distribution (typically Linux), software, and data, and a smaller swap disk, which is used in the event the VM runs out of memory. While two disks are typical, the VM can be configured to have many more disks, which can serve a variety of purposes including dedicated file storage or switching between entirely different Linux distributions. When multiple disks are added to a VM, configuration profiles are used to determine the disks that are accessible with the VM is powered on, as well as which of those disks serves as a primary root disk. Using tools provided by the service provider, disks can be created, resized, cloned and deleted. In addition, and by using a cloud manager, the VM can be migrated to another data center (if the provider operates multiple data centers), or to another location within the datacenter.

A representative core site (a datacenter) that supports cloud compute infrastructure is on a non-blocking, multistage switching network (e.g., CLOS) with Border Gateway Protocol (BGP) as the routing protocol between switches. In this infrastructure, the Hosts are physical boxes that contain the Guest VMs. The site may be managed by a control plane. In a representative embodiment, a core site runs a software package that operates as a host engine, which manages virtual machines (among other things) on a host. The host engine interoperates with a network-accessible database, which may be located remotely from the host. In particular, the host engine executes an allocator that is responsible for placing workloads onto available hardware. The job of the allocator, which may be implemented in the form of a Python function (e.g., get host), is to balance load across hardware in a customer-selected compute region, and to ensure that IP addresses, disk space, “slots”, all have availability to accept the new workload. The database, which may be implemented as a MySQL instance, is a singleton that acts both as a data source and as a message bus. In particular, the database acts as a message bus among end users interacting with the cloud compute service (typically accessed at a secure network-accessible domain), the allocator making VM placement decisions, and one or more other compute infrastructure hosts performing jobs in service of end user requests. For example, when an end user creates a guest VM on the compute service, a series of jobs are inserted into the database with a Host Identifier (Host ID) selected by the allocator. When that host wakes up from sleeping and looks for work in the database 504, it finds those jobs and starts executing on them. As a result, the compute host creates the guest VM, sets up its volumes and networks, and boots the guest VM with QEMU. QEMU is a generic and open source machine emulator and virtualizer. It emulates a computer's processor through dynamic binary translation and provides a set of different hardware and device models for the machine, enabling it to run a variety of guest operating systems. It can interoperate with Kernel-based Virtual Machine (KVM) to run virtual machines at near-native speed, and it can also emulate user-level processes, allowing applications compiled for one processor architecture to run on another. QEMU also has a migration framework that the host engine uses to move a guest VM from machine to machine.

In a representative embodiment, the control plane described above is managed “as-a-service” from a secure web application available, e.g., from a service provider domain or subdomain. After becoming a customer, secure permissioned access to the control plane is provided to enable the customer to provision and manage its workloads in the compute infrastructure.

Virtual machine provisioning and management by the above-described control plane is configured in one or more edge sites hosted within overlay network (e.g., CDN) regions and ECORs. This is sometimes referred to as Generalized Edge Compute (GEC). GEC includes the notion of migrating compute instances such as described above out of a core site (e.g., a datacenter) and into locations within the overlay network edge, e.g., in edge access networks including, without limitation, those networks in metropolitan areas, in emerging markets, and the like. In so doing, a GEC infrastructure addresses the goal of bringing compute closer to the end user, which is a core value proposition of well-designed and implemented overlay network solutions. To this end, and in one embodiment, GEC comprises a host engine running on overlay network edge hardware and software for the purposes of supporting generalized compute workloads. The term “generalized” in this context implies both compute that is not tied to the delivery of objects through a CDN, as well as software written in any programming language that runs within the context of a virtual machine.

Generalized Edge Compute takes cloud computing to the edge by embedding cloud computing capabilities into an highly-distributed overlay edge network. This solution combines the computing power of the cloud compute infrastructure with the proximity and efficiency of the edge to put workloads closer to users. While traditional cloud providers support VMs and containers in a relatively small number of core data centers, GEC extends this capability to edge Points of Presence (PoPs), bringing full stack computing power to hundreds of previously hard to reach locations. Deploying compute into an edge platform also takes advantage of existing operational tools, processes, and observability—enabling developers to innovate across the entire continuum of compute, providing a consistent experience from centralized cloud to distributed edge.

Provisioning the host engine onto the edge network enables a cloud compute solution that is highly distributed and that leverages the overlay network-supported ancillary features and functions that include, without limitation, data aggregation, log aggregation, NOCC support, safety features (zones, rollbacks), compliance (PCI, etc.), secrets, reliable configuration distribution, and role-based, standards-compliant, auditable remote access.

With the above as background, the techniques of this disclosure are now described.

### AI-Based Edge Architecture and Applications

According to this disclosure, AI/ML-based methods and systems leverage the unique benefits and advantages of overlay networks for computational and cost efficiencies.

By way of further background, FIG. 4 depicts a representative interaction of an end user with respect to a Large Language Model (LLM) 400 that runs on a set of processors, typically Graphics Processing Units (GPUs) 402. In FIG. 4, a request 401 is received by the LLM 400, and a response 403 is provided. In a typical use case, the request may be from an end user mobile device or computer over a network. The request may originate from some other application or system. ChatGPT is an example of an LLM that is accessed in this manner, typically over an API or other interface. Others include, without limitation, Meta Llama2, Google PaLM2, and the like. Following training (not shown), the request is received and passed through the model, which outputs/returns a prediction (an inference) based on its training.

Generally speaking, and as noted above, the cost of training, implementing, maintaining and updating the LLM is high, and there are few entities that have the capacity or capability to run these models. The techniques of this disclosure provide several solutions to this problem.

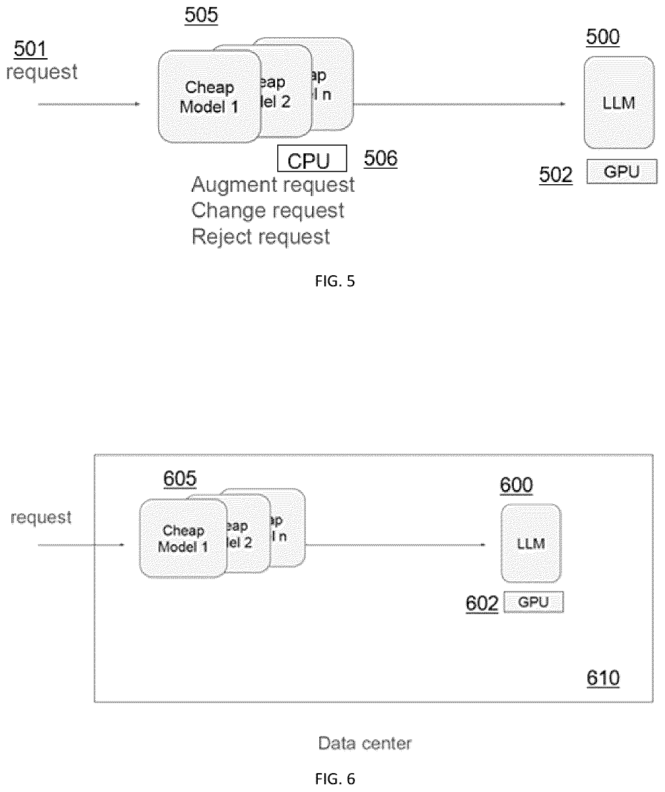

FIG. 5 depicts a first embodiment, wherein in lieu of delivering all requests to the LLM for handling directly, a set of one or more “cheap” models 505 are positioned in front of the LLM 500 running on GPUs 502. In this embodiment, a cheap model 505 in effect protects the back-end LLM 500 by performing some initial processing on a request, e.g., augmenting the request, changing the request, rejecting the request, and the like. In an example, a cheap model 505 augments a request with some additional context (e.g., the results of querying a local database associated with the cheap model), and inclusion of that additional context enhances the prediction returned by the LLM, or reduces the overall cost of obtaining it. Depending on this processing, the initial request 501 (or some variant thereof) may not even reach the back-end LLM, or that initial request may be altered in a way that makes its processing by the back-end more efficient, more accurate or less costly. More generally, the cheap model 505 provides a pre-screening function or operation with respect to a request before that request is otherwise provided to the LLM.

Moreover, and as compared to the back-end LLM 500, a cheap model 505 is smaller in scale and, in a typical implementation, the cheap model executes on an less costly infrastructure, e.g., a node in an edge network. Such nodes typically do not include large numbers of GPUs, and thus in the depicted embodiments the cheap model runs on CPUs 506 (or on CPUs and a small number of GPUs). As long as the CPU has is a powerful processor, has sufficient memory and can implement the model code efficiently, the cheap model-based solution provides useful results. In general, the performance of the cheap model depends on the model size and the complexity of the task for which it is being used, but the local task will be less And, these useful results may be aggregated or other combined to generate an input to the larger back-end, GPU-supported LLM if and when necessary. Or, in some circumstances the output of the cheap model may be good enough, so that use of the more expensive LLM is obviated. Stated another way, the approach (or selective use of the CPU-supported cheap model(s) in lieu of the more expensive GPU-supported LLM) in effect trades off a given solution's computational requirements with the accuracy of the model. Thus, according to one aspect of this disclosure, a set of one or more cheap model(s) execute primarily on CPUs while the LLM executes upstream from the cheap models, primarily on GPUs or even TPUs (Tensor Processing Units). In an appropriate circumstance, the cheap model provides the necessary inferencing, and although the accuracy of the prediction may not be as good as what the LLM would provide, the cost of obtaining the prediction is less.

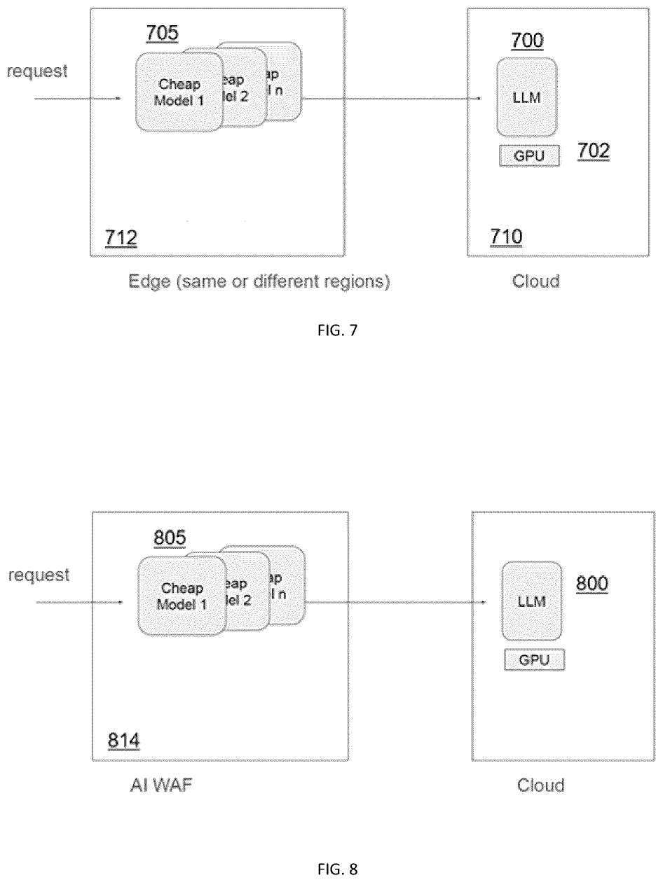

FIG. 6 depicts a variant embodiment wherein the cheap models 605 execute in a cloud compute infrastructure (e.g. in a data center) 610, once again in front of the back-end LLM 600 executing on one or more GPUs 602. A representative data center hosts the GEC infrastructure (or the like), as was described above. FIG. 7 depicts another variant embodiment wherein the cheap models 705 execute on the edge network 712 across the same or distinct edge regions, and the back-end LLM 700 executes in a cloud compute infrastructure 710, e.g., a service such as Akamai® Linode® that provides virtual machines and supporting infrastructure as-a-service (more formally, Platform-as-a-Service). A representative overlay network comprising the edge network is described above, and once again the cloud compute portion may be implemented as GEC.

The notion of “cheap” here is not limited to cost; a cheap model is one that is smaller and more lightweight as compared to an LLM (or other back-end ML model or system).

A set of cheap models configured across a set of edge regions or machines within an edge region enable efficient inferencing at the edge network, and they may be configured to provide cooperative or collaborative learning, such a running a graph database, performing API transaction security, and many more. More generally, each cheap model is a “sub-model” such that the set of cheap models together comprise a neural network made up of sub-models, and where individual models implement back-propagation to provide feedback or hints to one another. An example of such an architecture is described below.

FIG. 8 depicts a particular use case of a set of cheap models 805 configured to operate collaboratively and, in particular, to provide a Web Application Firewall (WAF)-style function 814 for the LLM itself. In this example, and depending on the nature or frequency of requests, the LLM 800 may exhibit particular execution vulnerabilities. Using cheap models 805 positioned on edge servers in front of the LLM 800, the cheap model(s) operate (e.g., by augmenting a request, changing the request, etc.) in a manner that reduces the likelihood of the execution vulnerabilities from being exploited, thereby providing the firewall-type function for the LLM and improving the overall operational efficiency of the AI system that includes these models. Or, more generally, the set of models perform necessary or desirable pre-work on one or more requests as necessary before the system runs the work on the back-end LLM. The nature and scope of the WAF-style LLM protection provided by cheap models is implementation-specific, e.g., depending on the size and complexity of the LLM.

The architecture in FIG. 8 may also be used (as a distributed AI) to identify potential fraudulent transactions targeted the edge nodes themselves.

FIG. 9 depicts another embodiment where the edge network supports Retrieval-Augmented Generation (RAG). RAG is the process of optimizing the output of an LLM to reference an authoritative knowledge base outside of its training data sources before generating a response. In this example, the edge network 912 (in front of the LLM 900) hosts a pre-trained RAG model 907 and an associated vector database (or search engine) 909. In the depicted operational flow, the request 901 is intercepted/received at the edge, and the RAG 907 is used to add context to the request before the resulting augmented request 903 is provided as an LLM input.

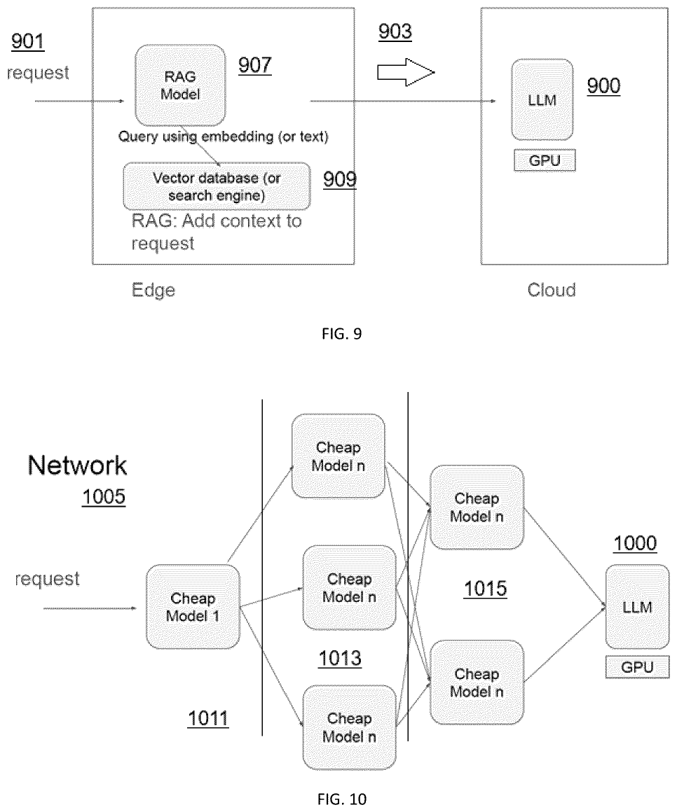

FIG. 10 depicts another embodiment comprising a network 1005 of cheap models, each of which has the capability of modifying an input to that model, and wherein the output of a particular model may be received as the input of another model. Together, the models inform each other of their predictions through these connections. In this embodiment, which is not intended to be limiting, the individual sub-models comprise a neural network. In this example, the network comprises an input layer 1011 of a single cheap model, an intermediate layer (akin to a hidden layer in an NN) 1013, and an output layer 1015 having two cheap models. The individual outputs of the models in the output layer are then provided to the LLM 1000.

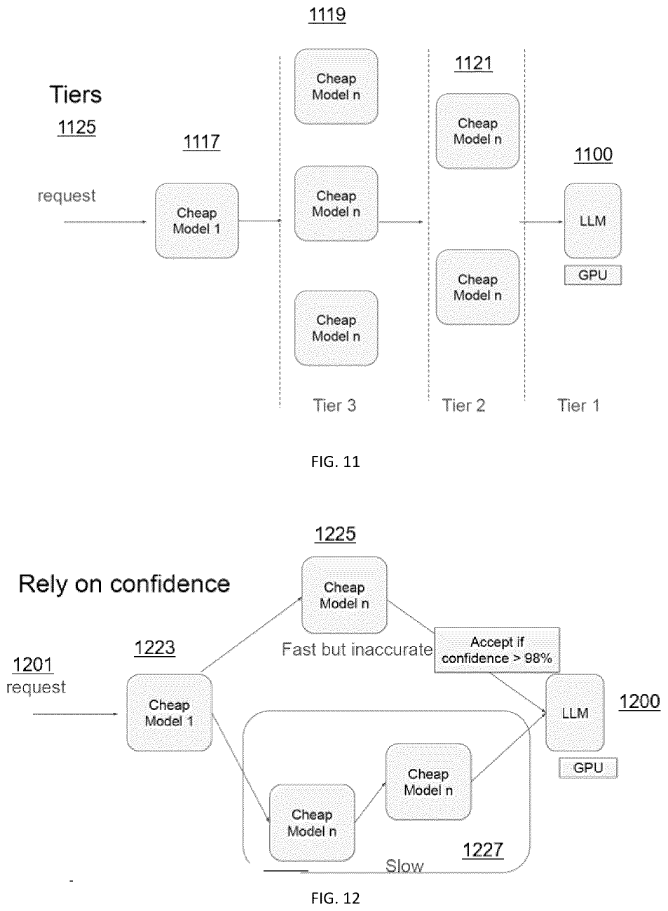

FIG. 11 depicts an alternative approach wherein the cheap models are organized in a tiered arrangement 1125. In this example, the output generated from the input layer 1117 is supplied to a first tier 1119 (Tier 3), with the output of the first tier processing then supplied to the second tier 1121 (Tier 2), and then with the output of the second tier processing then supplied to the LLM 1100 (Tier 1). Typically, the nature, cost or complexity of the models in the various tiers differs, with the tiers closer to the back-end providing more complexity/accuracy, but also at more cost in terms of computing resources. The number, complexity and arrangement of tiers may be varied. This architecture provides for a multi-tier AI solution.

FIG. 12 depicts yet another approach wherein different cheap models (or more generally sub-networks) have different capabilities relative to one another. In this example, the request 1201 is received at an input cheap model 1223, and the output of that cheap model is supplied to a fast cheap (but potentially inaccurate) model 1225, as well as to a sub-network 1227 (in this case that includes a pair of cheap models working together) that provides a slower response, but one that may be more accurate that the output of the fast cheap model. In this example, and as depicted, the output of the fast but inaccurate cheap model 1225 is then accepted and passed upstream to the LLM 1200 only if the system has sufficient confidence in its accuracy. If not, only output of the slow sub-network 1227 is used.

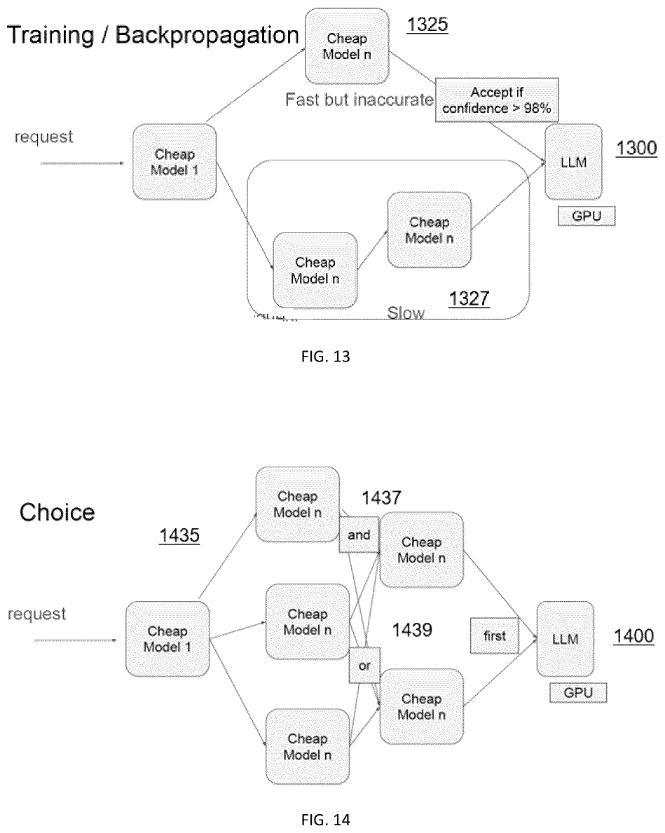

As depicted in FIG. 13, the above-described approach shown may also be useful for training and backpropagation. Backpropagation is the process used in AI to adjust the weights of a deep neural network. It reduces the loss between the predicted values and the actual values. In the FIG. 12 context, the outputs of the fast but potentially inaccurate model 1325 and the slow but potentially accurate sub-networks 1327 may be used (backpropagated) to adjust the LLM 1300 during training.

FIG. 14 depicts another embodiment wherein the network of cheap-models 1435 is structured with additional logic, such as AND and OR functions 1437 and 1439, and possibly fast/slow timing functions/gates such as described above in the embodiment depicted in FIG. 12.

The machine learning models located at the edge network may be language models that are smaller in size and scale as compared to the Large Language Model (LLM) supported in the back-end. An ML model at the edge may be an application-specific model, whereas the back-end model is a more general purpose model. The models located at an edge region (or set of such regions) may be considered to comprise a model chain or the front (input) layers of the back-end model.

The solutions here provide significant advantages. In the depicted embodiments, the cheap models are configured to be located, executed and managed at edge network nodes. As such, the deployment and execution efficiencies enabled by CDNs are leveraged to provide significant benefits in terms or cost reduction, reduced latency, scalability and reliability.

### Enabling Technologies

Generalizing, the techniques herein may be implemented in or in association with a computing platform, wherein one or more functions of the computing platform are implemented conveniently in a cloud-based architecture. As is well-known, cloud computing is a model of service delivery for enabling on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. Available services models that may be leveraged in whole or in part include: Software as a Service (SaaS) (the provider's applications running on cloud infrastructure); Platform as a service (PaaS) (the customer deploys applications that may be created using provider tools onto the cloud infrastructure); Infrastructure as a Service (IaaS) (customer provisions its own processing, storage, networks and other computing resources and can deploy and run operating systems and applications).

The platform may comprise co-located hardware and software resources, or resources that are physically, logically, virtually and/or geographically distinct. Communication networks used to communicate to and from the platform services may be packet-based, non-packet based, and secure or non-secure, or some combination thereof. Typically, the cloud computing environment has a set of high level functional components that include a front end identity manager, a business support services (BSS) function component, an operational support services (OSS) function component, and the compute cloud components themselves.

More generally, the techniques described herein are provided using a set of one or more computing-related entities (systems, machines, processes, programs, libraries, functions, or the like) that together facilitate or provide the described functionality described above. In a typical implementation, a representative machine on which the software executes comprises commodity hardware, an operating system, an application runtime environment, and a set of applications or processes and associated data, which provide the functionality of a given system or subsystem. As described, the functionality may be implemented in a standalone machine, or across a distributed set of machines. The functionality may be provided as a service, e.g., as a SaaS solution. An edge compute instance may be supported in a virtual environment.

While the above describes a particular order of operations performed by certain embodiments of the invention, it should be understood that such order is exemplary, as alternative embodiments may perform the operations in a different order, combine certain operations, overlap certain operations, or the like. References in the specification to a given embodiment indicate that the embodiment described may include a particular feature, structure, or characteristic, but every embodiment may not necessarily include the particular feature, structure, or characteristic.

While the disclosed subject matter has been described in the context of a method or process, the subject disclosure also relates to apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including an optical disk, a CD-ROM, and a magnetic-optical disk, a read-only memory (ROM), a random access memory (RAM), a magnetic or optical card, or any type of media suitable for storing electronic instructions, and each coupled to a computer system bus.

While given components of the system have been described separately, one of ordinary skill will appreciate that some of the functions may be combined or shared in given instructions, program sequences, code portions, and the like.

Preferably, the functionality is implemented in an application layer solution, although this is not a limitation, as portions of the identified functions may be built into an operating system (running TCP) or the like.

The functionality may be implemented with other application layer protocols besides HTTPS, such as SSL VPN, or any other protocol having similar operating characteristics.

The techniques herein may be used irrespective of the traffic type.

There is no limitation on the type of computing entity that may implement the client-side or server-side of the connection. Any computing entity (system, machine, device, program, process, utility, or the like) may act as the client or the server.

Finally, while given components of the system have been described separately, one of ordinary skill will appreciate that some of the functions may be combined or shared in given instructions, program sequences, code portions, and the like.

The techniques herein provide for improvements to a technology or technical field, namely, overlay networking, as well as improvements to the functioning of edge server itself, namely, by extending its conventional functionality as has been described.

The heterogeneous network may leverage local data collection techniques that include, without limitation, active and passive data collection, data traffic monitoring, packet inspection, application layer-based, operating system kernel-based, and otherwise.

An edge machine/process may exchange information (e.g., its local cheap model, or portion thereof) with a peer machine/process using any group-based or direct peer-to-peer based communication mechanism, including conventional HTTPS-based request and response, serialization-based request and response, etc. and such data sharing may be carried out over multicast, unicast or the like. Machines/processes may communicate with one another over wired and/or wireless connections. One particular technique that may be used to share models may use existing WAN and/or LAN infrastructure in the overlay network that is used for communicating other control information and data between and among edge server machines. Of course, the nature of the communication will depend on the type of model being built.

Models may be updated periodically, continuously, synchronously, asynchronously, on-demand, or in response to a given event, occurrence or trigger. From a temporal perspective, the steady state may be short, medium or long term.

There is no limitation on the type of learning or knowledge-based model that is implemented locally.

Particular machines/processes that implement the machine learning and share their knowledge to create emergent behavior according to the technique herein may be of any type including, without limitation, edge network computing nodes (which are typically rack-mounted in network-accessible data centers), Internet-of-Things (IoT) devices, cloud infrastructure-based computing nodes and resources, virtualized computing nodes, virtual machines, and the like.

The particular geographic and/or network extent of the model sharing is not intended to be limiting.

Local data collection techniques (for supporting local model building) include, without limitation, active and passive data collection, data traffic monitoring, packet inspection, application layer-based, operating system kernel-based, and otherwise.

There may be many different types of machine learning techniques that may be used to facilitate a given collaboration, and more than one technique may be used by given subsets of edge machines that are cooperating or collaborating in this manner. The nature of the data sharing across nodes will depend on the type of model being built. In one embodiment, the machine learning is based on a K-nearest neighbor algorithm. This approach is useful for an edge network-based environment since much of the data being used already resides on the edge node. In this approach, a local model (associated with a given machine) trains on a set of exemplars that are learned from the data collected. Exemplars represent lossy compression of the input data that has been seen. The K-nearest exemplars are then shared with the nearby nodes, typically in the form of a data set vector. The node that receives this data then adjusts its local knowledge vector accordingly (e.g., by averaging in the new vector, finding a median, etc.) to create the adjusted model, which can then be applied to the overlay network optimization task at hand.

In another embodiment, neural networks are used for the learning. Neural networks here may perform in-band learning, or out-of-band learning. In-band learning involves keeping track of pieces of interesting data (e.g., anomalies), and then gossiping this data to the nearby nodes. In out-of-band learning, the neural network comprises a set of weights (floating point numbers over which various mathematical operations are performed), and it is the set of weights that are shared to facilitate the collaboration. To this end, a receiving node would take the weights received and incorporate them in its weight matrix/vector, or the like. Another approach to training a neural network is to create a trained lightweight model (in the manner described) and then share it to a subset of the other nodes.

Edge machines herein may operate as on-line learners, which learn in real-time using streamed data, or off-line learners, which learn by training over and over on a single batch of data. Preferably, a node is a life-long learner, which is a node that becomes smarter the longer it operates in this collaborative manner.

The problem(s) being modeled by a particular model may be stationary or non-stationary.

Some edge nodes may use the described technique, while certain other nodes may be configured not to use the technique. A given node may provide this functionality only at certain times, or at certain times of day. A particular node may be managed by an overlay network configuration to provide a model in association with a particular constraint, e.g., a customer control, a domain, or the like.

The embodiments depicted herein are provided for exemplary purposes, but they are not intended to be limited. In this regard, the various networks depicted in FIGS. 5 through 14 and described above may be combined, reorganized and supplemented to provide the desired inferencing goals.

What is claimed follows below.

1. A method, comprising:
configuring one or more first machine learning models in a first network located between a client, and a second network, the second network hosting a second machine learning model, wherein, as between at least one first machine learning model and the second machine learning model, the first machine learning model provides inferencing at a lower cost but with less accuracy;
responsive to receipt of a request by a given one of the first machine learning models, generating a response to the request; and
forwarding the response onward to the second machine learning model for additional handling.

2. The method as described in claim 1, wherein the at least one first machine learning model executes primarily on one or more Central Processing Units (CPUs), and the second machine learning model executes primarily on one or more Graphics Processing Units (GPUs).

3. The method as described in claim 1, wherein, as between the first machine learning model and the second machine learning model, the first machine learning model is smaller in a scale of a language corpus on which the model is trained.

4. The method as described in claim 1, wherein the first network is one of: an edge region of a Content Delivery Network (CDN), and a datacenter hosting cloud compute infrastructure.

5. The method as described in claim 1, wherein the response to the request represents an initial processing of the request.

6. The method as described in claim 5, wherein the initial processing performs one of: augmenting the request with additional context, changing the request, and screening the request.

7. The method as described in claim 1, wherein the request originates at the client and is originally directed to the second machine learning model.

8. The method as described in claim 1, wherein the lower cost results from execution of the first machine learning model on infrastructure in the first network having an operating cost that is less than infrastructure in the second network on which the second machine learning model executes.

9. The method as described in claim 1, wherein the second machine learning model is a Large Language Model (LLM).

10. The method as described in claim 1, wherein the first network is an edge network, and the second network is a network-accessible cloud compute infrastructure.

11. The method as described in claim 1, wherein the one or more first machine learning models comprise a set of first machine learning models that execute in or across an overlay network operating region.

12. The method as described in claim 11, wherein the set of first machine learning models are configured to provide a collaborative learning inferencing task.

13. The method as described in claim 11, wherein the set of first machine learning models collectively comprise a neural network.

14. The method as described in claim 13, wherein at least one of the set of first machine learning models implements back-propagation to provide feedback or hints to others of the set of first machine learning models.

15. The method as described in claim 11, wherein the set of first machine learning models are configured to protect the second machine learning model against a given execution vulnerability.

16. The method as described in claim 11, wherein the set of first machine learning models are configured to perform preliminary work on the request before processing at the second machine learning model.

17. The method as described in claim 11, wherein at least one of the first machine learning models is associated with a Retrieval Augmented Generation (RAG) process that adds context to the request to generate an augmented request that is forwarded to the second machine learning model.

18. The method as described in claim 11, wherein at least some of the first machine learning models inform each other of respective inferencing outputs.

19. The method as described in claim 11, wherein the set of first machine learning models are configured in a tiered arrangement having one or more outputs generated at a first tier are supplied as one or more inputs to a second tier.

20. The method as described in claim 11, wherein at least a first one of the set of first machine learning models have a different capability relative to a second one of the set of first machine learning models.

21. The method as described in claim 11, wherein at least a first one of the set of first machine learning models is associated with additional operating logic.

22. The method as described in claim 11, wherein the set of first machine learning models comprise a model chain.
